(19) United States
(12) Patent Application Publication
(10) Pub. No.: US 2024/0304832 A1
(43) Pub. Date: Sep. 12, 2024

(54) Energy Source with a Passively-Heated Thermal Battery and Missile having the Energy Source

(71) Applicants: Diehl Energy Products GmbH, Röthenbach a. d. Pegnitz (DE); Diehl Defence GmbH & Co. KG, Überlingen (DE)

(72) Inventors: Walter PREISS, Röthenbach (DE); Dominik CLEMENT, Röthenbach (DE); Tobias KORTHALS, Konstanz (DE); Thomas KUHN, Heiligenberg (DE)

(21) Appl. No.: 18/394,114

(22) Filed: Dec. 22, 2023

(30) Foreign Application Priority Data
Dec. 22, 2022 (DE) 10 2022 004 875.2

(51) Int. Cl. H01M 6/36; F42B 15/00; H01M 6/46; H01M 6/50

(52) U.S. Cl. CPC H01M 6/36; F42B 15/00; H01M 6/46; H01M 6/5038; H01M 2220/20

(57) ABSTRACT

An energy source provides electrical energy in a missile, which is configured to heat at least one structural section during an intended flight, so that heat is available there. At least one thermal battery has at least one cell, which contains an electrolyte. The electrolyte is to be heated by the input of heat for providing the electrical energy at the thermal battery. At least one electrolyte can be thermally coupled to the structural section in order to transfer at least part of the heat provided at the structural section during flight from there to the electrolyte. A missile contains the energy source in which at least one electrolyte is thermally coupled to the structural section.

### CROSS-REFERENCE TO RELATED APPLICATION

This application claims the priority, under 35 U.S.C. § 119, of German Patent Application DE 10 2022 004 875.2, filed Dec. 22, 2022; the prior application is herewith incorporated by reference in its entirety.

### FIELD AND BACKGROUND OF THE INVENTION

The invention relates to an energy source having a thermal battery for providing electrical energy for or in a missile. The invention also relates to a missile having the energy source.

A number of missiles, in particular military missiles (for example guided missiles, projectiles or ammunition with internal electrical components, . . . ), require electrical energy to operate, for example for on-board navigation systems, flight control, guidance, seekers, cameras, etc. It is known from practice to provide electrical energy from a thermal battery for that purpose.

For example, the following is known from German Patent Application DE 199 58 411 A1: thermal batteries belong to the group of primary batteries. In contrast to the generally known batteries such as for example alkaline-manganese batteries and the so-called reserve batteries, in which the electrolyte is in a separate container until the battery is activated, in the thermal batteries the electrolyte is located in the thermal battery cell. In the stored state of the thermal battery, the electrolyte is in a solid form. The activation of a thermal battery takes place by using heat sources integrated in the thermal battery. Those heat sources are usually pyrotechnic heat sources. When the thermal battery is activated, the electrolyte melts. It is only in the molten electrolyte that the electrochemical and physical discharge processes then take place.

Depending on the composition of the electrolyte, its melting temperature is 350 to 650° C. Above the melting temperature, the electrolyte has good ion conductivity, which is important for the performance of the thermal battery. At room temperature, the ion conductivity tends to zero.

So far there have been two ways of solving that problem, which are also combined for particularly long operating or running times of known thermal batteries, to be specific that of supplying and storing a large amount of heat, or that of providing corresponding thermal insulation.

German Patent Application DE 199 58 411 A1 therefore describes a thermal battery with a battery cell which is disposed in a hermetically sealed cell shell. In order to obtain a thermal battery with a long operating or running time, a hermetically sealed outer shell, which is kept at a distance from the cell shell on all sides, is provided.

### SUMMARY OF THE INVENTION

It is accordingly an object of the invention to provide an energy source with a passively-heated thermal battery and a missile having the energy source, which overcome the hereinafore-mentioned disadvantages of the heretofore-known energy sources and missiles of this general type, and which provide improvements with regard to thermal batteries which are intended to provide electrical energy for or in a missile.

With the foregoing and other objects in view there is provided, in accordance with the invention, an energy source for providing electrical energy in an as-intended missile, which is set up to heat up at least at one structural section during an as-intended flight, so that heat is available there, having at least one thermal battery with at least one cell, which contains an electrolyte which, for providing the electrical energy at the thermal battery, is to be heated by the input of heat, and at least one of the electrolytes can be thermally coupled to the structural section in order to transfer at least part of the heat provided at the structural section during flight from there to the electrolyte.

Preferred or advantageous embodiments of the invention and of other invention categories become apparent from the further claims, from the following description and from the appended figures.

The energy source serves or is set up for providing electrical energy for or in an as-intended missile. In this case, the invention proceeds from a missile, or presupposes such a missile, which is set up to heat up at least at one structural section during an as-intended flight, so that heat is available there. The energy in the missile is to be made available during its as-intended flight. This energy does not have to be available from the start of the flight (launch of the missile). A supply of energy in a later phase of the flight is sufficient.

“As-intended” means that the energy source is adapted in terms of its structure/configuration to a specific missile or a specific type of missile and is set up for use there, for example is configured for the boundary conditions determined as a result, such as the geometry, etc. In other words, a missile in question is presumed to be known in relation to certain boundary conditions. The same applies correspondingly to the flight of the missile, for which certain preconditions are assumed to be met. In particular, this concerns its heating caused by air friction.

Therefore, in the context of the aforementioned as-intended suitability, the application also includes a description of properties of missiles and statements relating to them, even though the missile is not part of the energy source. However, these statements in any case apply analogously to the missile according to the invention described further below, and may not be explicitly repeated there again.

The energy source contains at least one thermal battery. The thermal battery contains at least one cell. Each of the cells contains an electrolyte and in particular two electrodes: a cathode and an anode. In this respect, the structural configuration corresponds to a conventional thermal battery. In order to provide the electrical energy at the thermal battery, the electrolyte is to be heated by the input of heat.

At least one, in particular more than one or all, of the electrolytes can be thermally coupled to the structural section. In an assembly state or operating state, the electrolyte in question is then actually thermally coupled to the structural section. The thermal coupling serves for transferring at least part of the heat provided at the structural section during flight from the structural section to the electrolyte. This applies during the operation of the energy source or in the state in which it is installed in the missile, to be specific when heat is actually generated at the structural element and is therefore available.

The term “missile” should be understood in this case as meaning in particular a military missile and in particular should be understood broadly, and then it also includes for example ammunition or projectiles that are to be supplied with electrical energy during their as-intended flight.

The heating up of the structural section of the missile is in particular aerodynamic heating in the sense of “high” heating. The latter means that, during its as-intended flight, the structural section reaches temperatures above 300° C., above 350° C., above 400° C. or above 500° C. and, after reaching them, also maintains them. The thermal battery or the cell or the electrolyte is also to be heated up in particular to temperatures of at least 350° C. or at least 400° C., or is actually heated up correspondingly during operation. The transfer of heat from the structural section to the electrolyte takes place in particular by using automatic heat conduction on the basis of a temperature gradient which exists from the structural section to the electrolyte.

The invention is based on the following findings: A thermal battery is an activatable battery and, as in the present case, preferably serves for the operation of a missile. It is known from practice to activate the thermal battery by a current pulse before a missile is fired. As a result, the missile can then be launched. The thermal battery serves in particular for supplying all the electrical loads for controlling the missile.

A thermal battery known from practice is formed of stacked/stacks of powder compacts. A cell is usually made up of:
a heat pellet: This serves for the pyrotechnic heating of the thermal battery.
an electrode disc: This is inert with respect to the functionality of the thermal battery, so it has no power-generating/chemical functionality within the thermal battery. This only functions as a heat accumulator, and therefore has an attenuating effect on the pyrotechnic heat input for the components adjacent to the electrode disc.
the actual electrochemically active cell, formed of an anode as the first electrode, an electrolyte and a cathode as the second electrode.

In the conventional thermal battery, this sequence of cells/elements repeats itself in the direction of the stack, and thus of electrical series connection, until the voltage requirement is fulfilled. In addition, so-called end-heats are used at the head and foot of the stacking/at the end of the stack in order to reduce the cooling via these ends and to replenish heat during the running time. The linear juxtaposition results in a so-called stack. This is then thermally and electrically insulated, with the thermal insulation accounting for a large part of the volume.

By contrast, the invention provides passive external heating for the thermal battery. “Passive” means that active heat generation in the missile is not necessary. To this extent, the heat occurs as intended automatically/as a secondary or waste product during the operation or flight of the missile. According to the invention, this heat that occurs anyway is used for heating up the thermal battery. “External” means that the heat required for the thermal battery is not generated within the thermal battery, as described as conventional above, but is supplied externally, i.e. from outside the thermal battery, to be specific from the structural section of the missile that does not belong to the thermal battery.

As a result, thanks to the invention, all the components with the exception of the electrochemically active cells, formed of the anode, the electrolyte and the cathode, can be dispensed with within the conventional stack explained above. The space available as a result (space that is freed by the elimination of electrode discs, heat pellets and end-heats) is either no longer required for the thermal battery, and is thus available elsewhere in the missile, or can be used to increase the electrical capacity of the thermal battery by additional cells or increasing the geometrical size of the cells. In practice, the electrical capacity of a thermal battery according to the invention can be almost doubled compared to the conventional thermal battery described above, with the volume or installation space remaining the same.

According to the invention, this results in a significant increase in the performance of the power supply in the missile, which can for example serve further power requirements, such as additional seekers, with the same volume of the thermal battery.

According to the invention, there is also the advantage or a dual benefit that: heat that is to be dissipated from the structural part can be dissipated to the thermal battery, where it can also be disposed of by absorption in the electrolyte. Further cooling measures for the structural part can thus be reduced or can be dispensed with completely. The invention therefore also brings about a cooling of the structural part or missile.

The invention is based on the finding that a thermal battery is only capable of performance as long as its internal temperature is uniformly above a certain limiting temperature. For example, such a limiting temperature is 350° C. When the thermal battery or electrolyte cools below this limiting temperature, the current-carrying capacity decreases significantly due to increasing internal resistances, although there would still be electrical capacity that could be used without the cooling. For this reason, a conventional thermal battery known so far contains a (in particular pyrotechnical) heat source, which is initiated at the beginning of drawing power and quickly heats up the thermal battery. In order to delay the subsequent cooling, the conventional thermal battery is thermally strongly insulated and additionally contains inert mass as a heat accumulator (electrode discs).

Thanks to the invention, in particular no cooling can take place if—which is true in the case of aerodynamic heating—heat is still continuously generated at the structural section during flight and is supplied from the structural section to the thermal battery, i.e. the battery is heated passively (the heat occurring at the structural section is as it were a waste product) externally (the heat is generated outside the thermal battery at the structural section or is available there). Therefore, both of the aforementioned conventional measures (insulation, heat accumulator) are not necessary and the thermal battery has much more electrical capacity with the same volume. Neither conventional heating pyrotechnics nor corresponding thermal insulation nor the inert heat accumulator are required according to the invention. As a result, not only the electrical capacity, but also the electrical performance of the thermal battery can be significantly improved, especially in the final approach of a missile to a target. In such a final approach, there is usually the highest power requirement.

A corresponding missile therefore contains the energy source in an assembly state. The at least one electrolyte is then thermally coupled to the structural section. In particular, the missile is set up to heat up at the structural section due to friction with air during flight. In particular, the heating up of the structural section takes place exclusively on the basis of corresponding air friction. The structural section is in particular a structural section that is at least thermally coupled with the outer skin of the missile. In particular, the structural section is a structural section of the outer skin of the missile, therefore part of the outer skin. In particular, the outer skin heats up in the flight or operation of the missile thermally by air friction. The structural section is in particular at least part of an underside of the missile. This applies to missiles that are not permanently rotating. The “underside” is related to their orientation during an as-intended flat flight of the missile straight ahead.

The structural section cooled by the invention (dissipation of heat) thus at least partially also fulfils the function of an otherwise necessary heat shield or a heat tile, since an active cooling of the structural section takes place there by the transport of heat to the thermal battery or to the electrolyte. In other words, corresponding heat shields or tiles are necessary in a reduced way or not at all, since the structural section is cooled.

In particular, the missile is set up to move in flight at supersonic speed. This usually causes sufficient aerodynamic heating of the outer skin to operate a thermal battery.

The invention is therefore also based on the finding that supersonic missiles are significantly heated up by air friction. It is a challenge to dissipate this energy. Therefore, with the passively heated thermal battery according to the invention, two positive effects are combined. On the one hand, thermal energy is consumed by the phase conversion of the electrolyte contained in the battery and is dissipated from the structural section. This achieves cooling of the structural section. On the other hand, the performance of the thermal battery is greatly enhanced by the passive heating (passive: the heating up by air friction occurs anyway and does not require any active heat generation). In other words, according to the invention, the passive external heating by air friction of the missile (providing heat at the structural section) and the ammunition at high flight speeds is used to heat up a thermal battery and at the same time to dissipate heat into the phase conversion of the electrolyte. According to the invention, this results in a passively heated thermal battery for use in missiles and ammunition with high aerodynamic heating. According to the invention, this results in an energy supply for missiles which move at supersonic speed and thereby undergo high heating. This allows passive heating of a thermal battery. This makes it possible to significantly increase the electrical capacity per volume of the thermal battery, since there is no need for the internal pyrotechnic heating source or the internal heat accumulator or the thermal insulation.

In a preferred embodiment, the energy source contains a heat conducting element. This has at least the concomitant effect—in the assembly state or operation—of bringing about the actual thermal coupling of the electrolyte and structural section. The heat conducting element is thermally coupled to the electrolyte. The heat conducting element can be thermally coupled to the structural section, or as explained above is coupled in the operating/assembly state. The heat conducting element is in particular a heat conducting paste or a heat conducting layer or a heat conducting body or a channel, etc. The heat conducting element brings about or improves the thermal coupling, in particular if the structural section is disposed away from the electrolyte, so the two cannot touch for heat coupling. In this case, the heat conducting element transfers the corresponding heat from the structural section to the electrolyte over the intermediate distance. This measure either allows an electrolyte lying away from the structural section to be thermally coupled to the structural section in the first place or allows the thermal coupling to be improved. This is achieved for example by the heat conducting element bringing about flat/full bearing contact by adapting the geometry of the two elements.

In a preferred embodiment, the thermal battery contains at least two assemblies. Each of the assemblies respectively contains at least one cell with a respective electrolyte. In particular, the assemblies may in this case be structurally, possibly also spatially, separate. This results in a modular structural configuration of the thermal battery. The thermal battery can consequently be spatially distributed better in the missile. In particular, it can consequently absorb or else dissipate heat that is respectively available at various locations of the missile. In other words, the missile can thus also be cooled at spatially distributed locations in a simplified manner.

In a preferred variant of this embodiment, at least two of the assemblies are electrically connected to form a complete battery. The electrical connection may be formed of a series and/or parallel connection. This allows powerful complete batteries to be created overall.

In a preferred embodiment, at least one of the electrolytes can be thermally coupled to the structural section in that the thermal battery (or its corresponding cell/section with the electrolyte) is directly attached to the structural section. “Directly” means on the one hand that no heat conducting element explained above is disposed between the structural section and the thermal battery/cell/electrolyte. Structural parts of the thermal battery itself, such as for example a mandatory enclosure/container/housing for the electrolyte, are not considered to be a heat conducting element. On the other hand, a heat conducting element may also only take the form of a minimal element, for example a thin layer of a heat conducting paste or a film-like geometrical adaptation structure. In this case, the thermal element turns into almost a zero element. “Thin” means that its geometrical thickness is very much smaller than the geometrical dimensions of the thermal battery/electrolyte, for example by at least a factor of 10, 100, 1000, etc.

In other words, there is therefore no relevant thermal element between the structural section and the thermal battery, so that they are directly attached to each other. In particular, a direct thermal coupling of the two elements takes place by having them bearing against each other. This results in a thermally as well as geometrically particularly effective energy source as well as the aforementioned cooling of the structural section.

In a preferred embodiment, the structural section has a certain geometry. The thermal battery (or cell, electrolyte) then has, at least in the region of the electrolyte, a counter-geometry adapted to the geometry in such a way that, for thermal coupling, the thermal battery and the structural section can be placed flat against each other or, in the assembly state, lie correspondingly flat against each other. In other words, the thermal battery is configured to be “contour-appropriate”, i.e. adapted to bear against the contour of the structural section or the missile. The adaptation of the geometry and the counter-geometry takes place in particular in the course of direct attachment as explained above. This likewise results in a particularly good thermal coupling of the electrolyte and the structural section as well as a particularly space-saving configuration of the thermal battery in the missile.

In a preferred embodiment, the thermal battery is itself formed as flat, at least in the region of the electrolyte (see above), and for bearing with its flat side against the structural section. In other words, the thermal battery is for example of a flat-cuboidal configuration, somewhat in the manner of a layer covering the structural section, therefore in the assembly state is attached with its or a flat side to the structural section. This also leads to a thermally and geometrically particularly favorable configuration of the thermal battery or the missile with thermal battery system. “Flat” means that a height of the thermal battery is smaller than its transverse extent, for example at least by a factor of 5, 10, 20, 50 or 100.

The following embodiments always assume at least one of the electrolytes, which is/are actually thermally coupled as intended to the structural section in an assembly state.

In a preferred embodiment, at least one of these electrolytes is not assigned an active, in particular pyrotechnic, heat source. “Active” means that the heat source itself contains stored electrical, chemical or other energy or that further energy would have to be supplied to it.

In a preferred embodiment, at least one of these electrolytes is not assigned thermal insulation. In particular, no thermal insulation is present at least in the region of the thermal coupling of the structural section and the electrolyte.

In a preferred embodiment, at least one of these electrolytes is not assigned an internal heat accumulator of the thermal battery. A corresponding internal heat accumulator refers to an additional component of the thermal battery, in the form of a mass that is inert at least with regard to its storage property and does not contribute to the generation of energy, such as for example the electrode discs mentioned above. Not mentioned herein however are parasitic heat storage properties of the components of the thermal battery present according to the invention, such as for example heat storage properties of the electrolyte, the electrodes, a housing, etc.

The absence of the corresponding components (active heat source, insulation, heat accumulator) brings about the aforementioned saving of the installation space and weight of the thermal battery. This also leads to a particularly simple thermal battery.

With the objects of the invention in view, there is also provided a missile according to the invention. The corresponding missile and at least some of its possible embodiments as well as the respective advantages have already been explained analogously in conjunction with the energy source according to the invention.

Again summarized: The missile has the energy source according to the invention; at least one electrolyte is thermally coupled to the structural section. In particular, the missile heats up at the structural section due to air friction during flight. In particular, the structural section is at least thermally coupled to the outer skin of the missile. In particular, the structural section is at least a part of an underside of the missile. In particular, the missile is a supersonic missile.

The invention is based on the following findings, observations or considerations and has furthermore the following preferred embodiments. These embodiments are also sometimes referred to as “the invention” for the sake of simplicity. The embodiments may in this case also contain parts or combinations of the aforementioned embodiments or correspond to them and/or possibly also include embodiments which have not yet been mentioned.

The passively externally heated thermal battery according to the invention is in particular integrated in the outer shell of a correspondingly long and fast flying missile or ammunition in a contour-appropriate manner, so that it is passively heated up to at least 400° C. by the frictional resistance during flight and consequently the electrolyte becomes electrically conductive and the battery becomes operational. Especially during the final approach of the missile to an as-intended target, where the maximum electrical power is usually required, the battery is at operating temperature. The usual problems with cooling as a limiting factor of the performance of the thermal battery at the end of the running time therefore do not arise. Only the capacity then limits the performance. Due to the active heat sources (pyrotechnic compacts) and heat accumulators (electrode discs) that can be saved or are not present, it is possible to significantly increase the electrical capacity of the thermal battery, with the volume remaining the same as compared to a conventional thermal battery.

The entire thermal battery or the complete battery can be modularly constructed from a number of individual assemblies. Each assembly may in this case contain any number of cells. The resulting modular principle can be used for example to electrically connect a number of flat, i.e. panel-shaped, assemblies to one another. The individual assemblies may in this case be distributed at the locations or sides of the missile that are subjected to the greatest thermal loading, for example the underside of the missile (non-rotating missile). Their functionality is consequently similar to that of a heat shield/cooling device to be attached there.

Other features which are considered as characteristic for the invention are set forth in the appended claims.

Although the invention is illustrated and described herein as embodied in an energy source with a passively-heated thermal battery and a missile having the energy source, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, longitudinal-sectional view of a missile according to the invention with an energy source according to the invention; and

FIG. 2 is a fragmentary, perspective view of the missile of FIG. 1 with an alternative energy source, which is taken along a line II-II of FIG. 1, in the direction of the arrows.

### DETAILED DESCRIPTION OF THE INVENTION

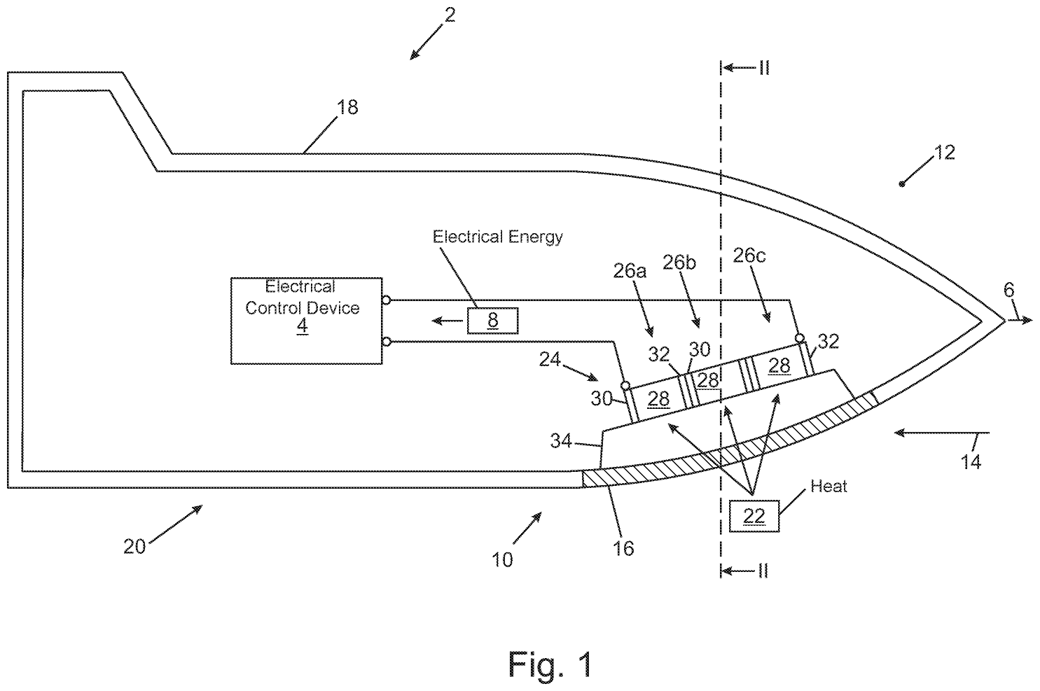

Referring now to the figures of the drawings in detail and first, particularly, to FIG. 1 thereof, there is seen a greatly-stylized representation of a missile 2, in this case a military guided missile. This missile contains an electrical control device 4 to guide the missile during an as-intended flight 6 (indicated by an arrow in a planar straight-ahead flight direction) to a target that is not shown, in order to engage the target. For its operation, the missile 2 or the control device 4 requires electrical energy 8 (likewise indicated by an arrow). In order to provide the electrical energy 8, the missile 2 contains an energy source 10.

During its flight 6 at supersonic velocity through surrounding air 12, this air flows against the missile 2 in the direction of an arrow 14. At a structural section 16 that is only symbolically indicated therein (shown by dashed lines in the figure), the missile heats up during the flight 6 due to friction with the air 12. This heating is caused exclusively by the oncoming flow of air 12, which means that it is aerodynamic heating.

The structural section 16 is a section of an outer skin 18 of the missile 2 and is consequently thermally coupled with it. The structural section 16 is part of an underside 20 of the missile 2. The missile 2 is a missile that is not permanently rotating and moves at supersonic speed (direction of the arrow 6) during its flight 6.

The energy source 10 serves for generating or providing the electrical energy 8 in the missile 2, which heats up at the structural section 16 during its flight 6, so heat 22 generated there due to air friction (symbolically shown) is available.

The power source 10 contains a thermal battery 24. In the example, the thermal battery 24 contains three cells 26a-c. Each of the cells 26a-c respectively contains an electrolyte 28, a cathode 30 and an anode 32. The cells 26a-c are electrically connected in series in this case. The first cathode 30 and last anode 32 in the series connection represent unspecified electrical output poles of the thermal battery 24, which supply the electrical energy 8 to the control device 4 via unspecified electrical lines.

In order to provide or generate the electrical energy 8, the thermal battery 24 is to be heated by the input of heat 22, which is shown in FIG. 1 by arrows. In order to accomplish this heating, all three electrolytes 28 are respectively thermally coupled to the structural section 16. Thanks to this coupling, after it occurs, the heat 22 is at least partially transported away from the structural section 16 and transferred to the thermal battery 24 or the electrolyte 28. Since the heat 22 permanently occurs or is regenerated or replenished due to the air friction during flight 6 until it ends (successful arrival of the missile 2 at the target), the thermal battery 24 is heated up to 400° C. and kept at this temperature. Thus, until the end of the flight 6 (arrival at the target) of the missile 2, the electrolyte 28 is kept at operating temperature and the thermal battery 24 provides permanent and sufficient electrical energy 8.

Both during and directly after firing/launching of the missile 2, the energy 8 is not yet available. This is so because it is only during flight that the structural section 16 is heated and, as a consequence, so too is the electrolyte 28, whereby the provision of energy 8 begins.

However, this is not critical in view of the as-intended flight time of the missile 2. The energy 8 is available soon enough to supply the missile 2 in time and from then on permanently.

In order to accomplish the thermal coupling between the electrolyte 28 and the structural section 16, the energy source 10 contains a heat conducting element 34, which is disposed between the structural section 16 and the thermal battery 24 and is thermally coupled both to the structural section 16 and to the thermal battery 24 and consequently the electrolyte 28. The heat conducting element 34 has sufficient thermal conductivity properties to transfer the heat 22 sufficiently quickly and in sufficient quantity from the structural section 16 to the electrolyte 28. The structural section 16 serves as the only source of heat 22 for the thermal battery 24. The electrolytes 28 are not assigned any further active heat source. The heating up of the electrolyte 28 due to the supplied heat 22 therefore takes place purely externally from outside the thermal battery 24 and passively, since the heat 22 occurs anyway at the structural section 16 during the flight 6 of the missile 2 due to the friction with the air 12, so to speak as a by-product. The electrolyte 28 or the thermal battery 24 is also not assigned any thermal insulation, since the heat 22 is permanently replenished and consequently heat losses at the thermal battery 24 are unproblematic. For the same reason, no internal inert heat accumulator is provided in the thermal battery 24 either. The heat storage properties of the existing elements of the thermal battery 24 (electrolyte 28, cathode 30, anode 32, housing not shown in detail, . . . ) are not mentioned herein because, although these elements have “parasitic” heat storage properties, they are or must be functionally present in the thermal battery 24 anyway. However, they are not present solely for the purpose of heat storage and are therefore not “inert” in the present sense.

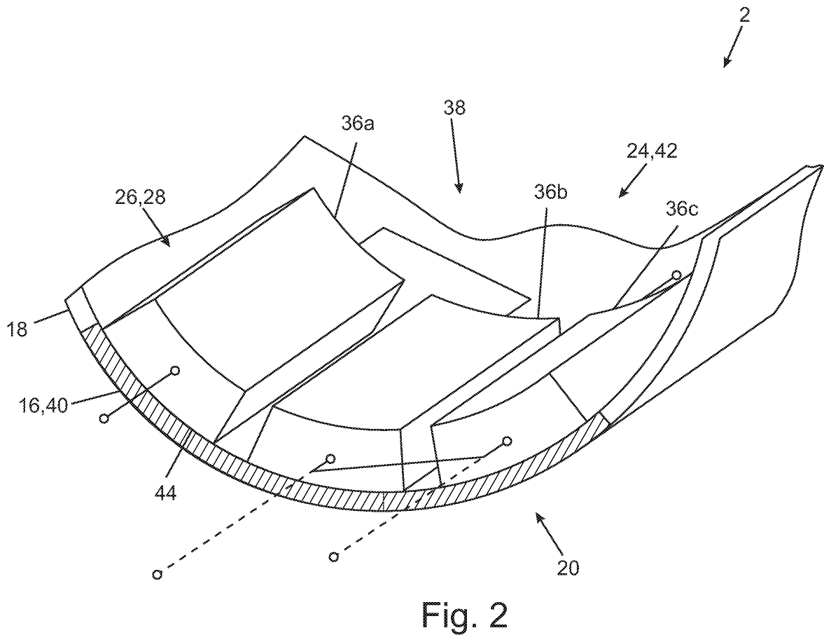

FIG. 2 shows a cross section through part of the missile 2 along the plane II-II in FIG. 1, to be specific its underside 20. In contrast to the embodiment according to FIG. 1, in this case the thermal battery 24 is alternatively configured and has altogether three assemblies 36a-c. Each of the assemblies 36a-c contains a number of cells 26, not shown in detail therein, with respective electrolytes 28. All three assemblies 36a-c are electrically connected in series, which is only symbolically indicated in FIG. 2. They are consequently connected to form a complete battery 38 in the form of the thermal battery 24. In an alternative configuration indicated by dashed lines, a complete battery 38 which contains the assemblies 36a, 36b is formed. The third assembly 36c forms in this case—depending on the perspective—a further partial battery of the thermal battery 24 or a separate thermal battery 24. The electrical connection between the assemblies 36b, 36c is then omitted. The complete battery 38 and further partial battery then serve for supplying different loads in the missile 2.

In contrast to FIG. 1, in FIG. 2 the heat conducting element 34 has been dispensed with. The thermal battery 24 or the assemblies 36a-36c are directly attached to the structural section 16. The thermal battery 24 and the structural section 16 therefore touch each other or lie against each other. This applies correspondingly to the electrolyte 28, with only a thermally conductive housing or its wall (not shown) being disposed between the electrolyte 28 and the structural section 16, but this does not represent a heat conducting element 34 in the sense of the present invention.

The structural section 16 has a certain geometry 40 in this case, to be specific a circumferential section of a straight circular cylinder jacket. The thermal battery 24 has a corresponding counter-geometry 42, which is adapted to the geometry 40, and therefore likewise has the form of a straight circular cylinder jacket, the outer radius of which corresponds to the inner radius of the jacket of the geometry 40. Consequently, for thermal coupling, the structural section 16 and the thermal battery 24 lie flat against each other.

The thermal battery 24 is formed to be flat in this case, to be specific as a circular cylinder jacket section, so that it is formed for bearing with its flat side 44 (radially outward facing outer surface of the cylinder jacket) against the structural section 16, or correspondingly lies against it.

The following is a summary list of reference numerals and the corresponding structure used in the above description of the invention:

### LIST OF DESIGNATIONS

2 Missile
4 Control device
6 Flight
8 Energy (electrical)
10 Energy source
12 Air
14 Arrow
16 Structural section
18 Outer skin
20 Underside
22 Heat
24 Thermal battery
26a-c Cell
28 Electrolyte
30 Cathode
32 Anode
34 Heat conducting element
36a-c Assembly
38 Complete battery
40 Geometry
42 Counter-geometry
44 Flat side

1. An energy source for providing electrical energy in a missile configured to provide heat for heating at least one structural section of the missile during an intended flight, the energy source comprising:
at least one thermal battery including at least one cell containing an electrolyte to be heated by inputting the heat for providing the electrical energy at the thermal battery;
said electrolyte of said at least one cell configured to be thermally coupled to said at least one structural section in order to transfer at least part of the heat from said at least one structural section during flight to said electrolyte.

2. The energy source according to claim 1, which further comprises a heat conducting element bringing about said thermal coupling of said electrolyte and said at least one structural section, said heat conducting element being thermally coupled to said electrolyte and being configured to be thermally coupled to said at least one structural section.

3. The energy source according to claim 1, wherein said thermal battery includes at least two assemblies each having at least one cell with a respective electrolyte.

4. The energy source according to claim 3, wherein at least two of said assemblies are electrically interconnected to form a complete battery.

5. The energy source according to claim 1, wherein said electrolyte is one of a plurality of electrolytes, and at least one of said electrolytes is configured to be thermally coupled to said at least one structural section by directly attaching said thermal battery to said at least one structural section.

6. The energy source according to claim 1, wherein said at least one structural section has a certain geometry and said thermal battery has, at least in a region of said electrolyte, a counter-geometry adapted to said certain geometry and permitting said at least one structural section and said thermal battery to be placed flat against each other, for thermal coupling.

7. The energy source according to claim 1, wherein said thermal battery has a flat side, at least in a region of said electrolyte, and said flat side bears against said at least one structural section.

8. The energy source according to claim 1, wherein said electrolyte is one of a plurality of electrolytes, and at least one of said electrolytes is configured to be thermally coupled to said at least one structural section and is not associated with an active heat source.

9. The energy source according to claim 1, wherein said electrolyte is one of a plurality of electrolytes, and at least one of said electrolytes is configured to be thermally coupled to said at least one structural section and is not associated with a thermal insulation.

10. The energy source according to claim 1, wherein said electrolyte is one of a plurality of electrolytes, and at least one of said electrolytes is configured to be thermally coupled to said at least one structural section and is not associated with an internal heat accumulator of said thermal battery.

11. A missile, comprising:
the energy source according to claim 1;
said electrolyte of the energy source being at least one electrolyte thermally coupled to said at least one structural section.

12. The missile according to claim 11, wherein the missile is configured to heat said at least one structural section due to friction with air during flight.

13. The missile according to claim 11, wherein said at least one structural section is at least thermally coupled with an outer skin of the missile.

14. The missile according to claim 12, wherein said at least one structural section is at least thermally coupled with an outer skin of the missile.

15. The missile according to claim 11, wherein said at least one structural section is at least part of an underside of the missile.

16. The missile according to claim 13, wherein said at least one structural section is at least part of an underside of the missile.

17. The missile according to claim 11, wherein the missile is configured to move in flight at supersonic speed.

18. The missile according to claim 14, wherein the missile is configured to move in flight at supersonic speed.
